(19) United States
(12) Patent Application Publication
(10) Pub. No.: US 2003/0233782 A1
(43) Pub. Date: Dec. 25, 2003

(54) Spinner bait fishing lure

(76) Inventor: Rodger A. Routsaw, Newaygo, MI (US)

Correspondence Address: PRICE HENEVELD COOPER DEWITT & LITTON, 695 KENMOOR, S.E., P O BOX 2567, GRAND RAPIDS, MI, 49501, US

(21) Appl. No.: 10/438,488

(22) Filed: May 15, 2003

Related U.S. Application Data
(60) Provisional application No. 60/389,793, filed on Jun. 19, 2002.

(51) Int. Cl. A01K 85/00

(52) U.S. Cl. 43/42.13

(57) ABSTRACT

A spinner bait fishing lure includes a wiring harness that has a plurality of wires, each of which have a first end that connects to an eyelet of a hook and which are contained within a lure body formed around the eyelet of the hook. The wiring harness includes a central region shaped for attaching the lure to a fishing line and each of the wires include a second loop at a second end. The wires are substantially parallel between the first loop and the central region and diverge from the central region at an angle that is symmetrical about a center line of the lure body. Swivels are used to attach spinner blades to second ends of each of the wires.

This application claims the benefit of U.S. Provisional Application Serial No. 60/389,793, filed Jun. 19, 2002, the entire disclosure of which is hereby incorporated herein by reference.

### BACKGROUND OF THE INVENTION

The present invention is generally directed to a fishing lure and, more specifically, to a spinner bait fishing lure.

Fishing lures that include spinners come in various configurations. For example, U.S. Pat. No. 4,881,341 discloses a fishing lure that includes two spinners formed of a ribbon or band-like member in the shape of either a half loop or full loop. The spinners are attached at an angle to a shaft of the lure such that the two spinners rotate about the axis of the shaft in opposite directions to mitigate twist or torque on an associated fishing line. In such fishing lures, the spinner elements are added to the lure as an aid to attracting fish. The spinners turn to create both movement and vibration in the water, which is visually and audibly attractive to a fish.

U.S. Pat. No. 4,133,135 discloses a spinner bait fishing lure having two parallel wires extending from a lure body, each of which supports a spinner blade adjacent an end of the wire and with both of the spinner blades being placed in alignment with a hook that extends from the body in a direction opposite that of the wires. As the two blades are placed in alignment, the tendency of the spinner bait to roll over or to vary from side to side is reduced.

U.S. Pat. No. 4,003,154 is directed to a spinner bait fishing lure, which includes a wiring harness with one end attached to a hook with a lead body of the lure being formed around the attachment point of the hook and the wiring harness. A central portion of the wiring harness is configured with a loop for attaching a line to the lure and a second end of the wiring harness, including a loop for receiving a three-legged swivel, which includes a spinner attached to two of the legs.

Prior art spinner bait fishing lures have used spinner blades of various designs and shapes, such as tear-drop spinners, which are shaped in the form of a slightly concave teardrop, and willow-leaf spinners, which have lengths greater than their widths and a slightly concave shape to impart spin when the lure is retrieved. Commonly, the spinner blades have been silver in color as this color tends to reflect the sun's rays as the spinner blade rotates in the water and attracts fish. It is commonly thought that such spinners resemble small game fish and other bait fish upon which larger fish feed, thereby increasing the attraction of the lure. Spinner blades may also be colored to simulate colors of other game fish and, depending upon the time of year, certain colors may be more effective than others. It is generally thought that the control of lure vibration, color and spinner blade action is important as it is thought that the attractiveness of the lure to the fish depends upon multiple factors, such as water clarity, depth, temperature, weather conditions and the like.

### SUMMARY OF THE INVENTION

One embodiment of the present invention is directed to a fishing lure that includes a hook, a wiring harness, a lure body, a pair of spinner blades and a pair of swivels. The wiring harness includes a first wire and a second wire, with each of the first and second wires having a first loop for attaching the first and second wires to an eyelet of the hook at a first end. The first and second wires have a central region shaped for attaching the lure to a fishing line and a second loop at a second end. The first and second wires are substantially parallel between the first loop and the central region and diverge from the central region at an angle that is substantially symmetrical about a center line. The lure body is formed around the eyelet of the hook and the center line extends along a longitudinal portion of the lure body. The first and second spinners each include an aperture approximate one end of the first and second spinners. The first swivel attaches the first spinner to the second loop of the first wire and the second swivel attaches the second spinner to the second loop of the second wire. According to alternative embodiments, the first and second spinners may be willow-leaf shaped spinners or tear-drop shaped spinners.

According to another embodiment, the lure body is made of lead. According to yet another embodiment, the lure body is shaped to receive a skirt along an end of the lure that extends around a shaft of the hook. According to still another embodiment of the present invention, the lure includes a plastic skirt positioned on the lure body, which includes a fringed portion that covers the shaft of the hook. The hook may be a barbed hook or a barbless hook. According to another embodiment of the present invention, the angle at which the first and second wires of the wiring harness diverge from the central region is between about ten and forty degrees.

These and other features, advantages and objects of the present invention will be further understood and appreciated by those skilled in the art by reference to the following specification, claims and appended drawings.

### BRIEF DESCRIPTION OF THE DRAWINGS

In the drawings:

FIG. 1 is a side view in partial cross-section of a spinner bait fishing lure, according to an embodiment of the present invention;

FIG. 2 is a top view in partial cross-section of the spinner bait fishing lure of FIG. 1; and

FIG. 3 is a perspective view of a spinner bait fishing lure, according to another embodiment of the present invention.

### DETAILED DESCRIPTION OF THE PREFERRED EMBODIMENT(S)

One embodiment of the present invention is directed to a spinner bait fishing lure that includes a wiring harness that has first and second wires, with each of the first and second wires having a first loop for attaching the first and second wires to an eyelet of a hook at a first end, a central region shaped for attaching the lure to a fishing line and a second loop at a second end. The first and second wires are substantially parallel between the first loop and the central region and diverge from the central region at an angle that is symmetrical about a center line, which extends along a longitudinal portion of a lure body. Spinner blades are attached with swivels to the second end of each of the first and second wires.

The spinner blades may take various forms, e.g., willow-leaf or tear-drop shaped, and may include various finishes, but are preferably reflective so as to enhance the ability of the fishing lure to attract fish. By positioning the spinner blades at an angle that is symmetrical about a center line of the lure body, the lure travels through the water in a manner that does not substantially twist or torque an associated fishing line. That is, utilizing two equally sized spinner blades that are spaced approximately the same angle from a center line of the lure body allows the lure to run straight through the water and reduces the tendency of the spinner bait to roll over or vary to the right or left. Further, such a lure provides an appreciable amount of vibration as the lure is being retrieved through the water, thus, also rendering the lure more attractive to fish.

It should be appreciated that according to the present invention, more than two spinner blades can be utilized. For example, the wiring harness may include three wires and, in this configuration, two of the wires are placed at an angle that is symmetric about a center line of a lure body with a third wire placed along the center line of the lure body. It should also be appreciated that if an even number of spinner blades is desired, the spinner blades can be placed at angles which are symmetrical about the center line of the lure body. Thus, according to the present invention, more than two spinner blades can be added to the fishing lure, which increases the vibration provided into the water, as well as the reflection from the spinner blades as they rotate as the lure is being pulled through the water. Accordingly, a lure designed according to the present invention is generally more successful in attracting fish than spinner bait fishing lures of the prior art.

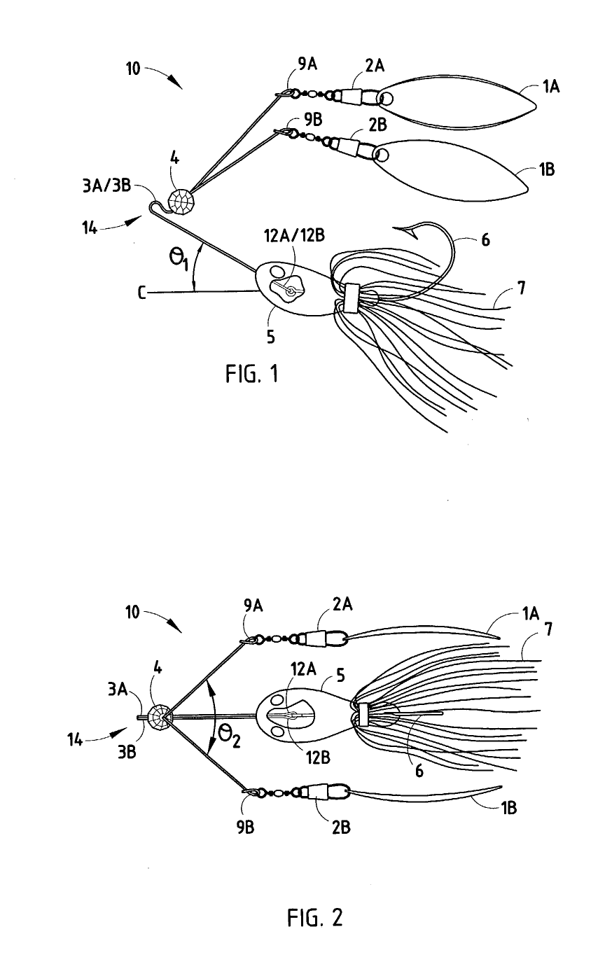

As is shown in FIGS. 1 and 2, the spinner bait fishing lure 10 includes two wires 3A and 3B that each include a first loop 12A and 12B, respectively, at a first end of the wires 3A and 3B. The loops 12A and 12B attach to an eyelet of hook 6. The hook 6 is positioned along a center line C of a lure body 5. The first and second wires 3A and 3B extend from the lure body 5 at an angle (θᵢ), e.g., thirty degrees, with respect to the center line C. The first and second wires 3A and 3B include a central region 14 that is shaped for attaching the lure 10 to a fishing line and also include second loops 9A and 9B, respectively, formed at a second end of the wires 3A and 3B. A swivel 2A couples a spinner blade 1A to the loop 9A of the wire 3A. A swivel 2B couples the spinner blade 1B to the loop 2B of the wire 3B. The swivels 2A and 2B allow the spinner blades 1A and 1B, respectively, to rotate freely as the lure 10 is dragged through the water.

As is shown in FIG. 1, the wires 3A and 3B may be retained by a plastic bead 4. Alternatively, the bead 4 may be omitted and the wires 3A and 3B may be welded together.

During manufacturing, the second ends of the wires 3A and 3B are bent to form a V-shape with each of the wires 3A and 3B being bent symmetrically with respect to the center line C to form an angle of θ₂, e.g., ten to forty degrees. One end of the lure body 5 is configured to receive a skirt 7, which includes a fringed portion that, at least, partially covers a shaft of the hook 6 to conceal the hook 6 from a fish. The wires 3A and 3B may be formed from various rust resistant materials, such as stainless steel, and may be fashioned from a wire having a variety of diameters. The lure body 5 simulates a head of a beetle or other bait and can be made of various materials, e.g., lead, plastic, etc. Further, the hook 6 may accept various other bait, such as plastic worms, plastic grubs and the like, as desired by an individual user.

It should be appreciated that in order for the lure 10 to run true in the water, the spinner blades utilized therewith should be of the same size and configuration and be symmetrically positioned about the center line with the exception of the lure that includes an odd number of spinner blades, which may utilize a different spinner size and/or configuration in the middle. During manufacturing, loops 12A and 12B are formed at a first end of each of the wires 3A and 3B and are connected to an eyelet of the hook 6. The two wires 3A and 3B and the hook 6 are molded together in the lure body 5, which may be formed of lead. The plastic bead 4 is then slid over the second end of the wires 3A and 3B and the wires 3A and 3B are then bent to form a V-shape, which is symmetrical about the center line of the lure body 5. The second end of the wires 3A and 3B are then fashioned into a loop with swivels, e.g., snap swivels, being placed on each of the loops 9A and 9B with an opposite end of the swivel being placed in the aperture formed in the blades 1A and 1B. The skirt 7 is then slid over a lower portion of the lure body 5, which is configured to accept the skirt.

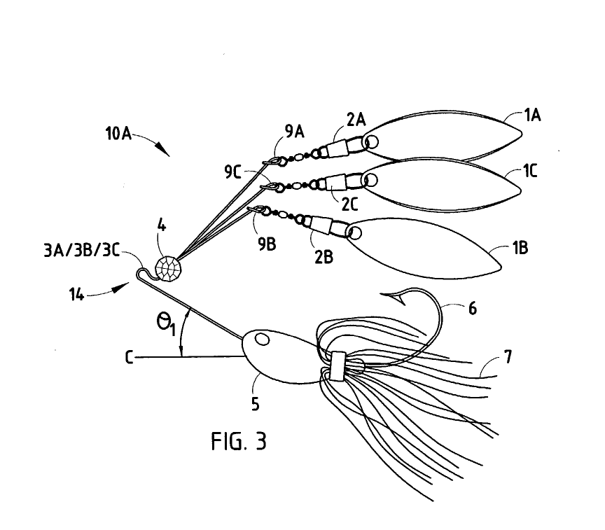

FIG. 3 shows another lure 10A that is similar to the lure 10 (shown in FIGS. 1 and 2), with the exception that a third wire 3C is symmetrically positioned between wires 3A and 3B.

A third spinner blade 1C is coupled to a third swivel 2C, which attaches the spinner blade 1C to a loop 9C formed in a second end of the wire 3C. Loops (not shown) formed at first ends of the wires 3A, 3B and 3C connect to an eyelet (not shown) of hook 6

Accordingly, a fishing lure spinner bait design with at least two wires molded in a lure body and a hook have been described herein. The wires are formed in an “R” shape and each include one end that is attached to an eyelet of a hook, which is later molded within a lure body. The wires are parallel to each other as they leave the lure body and are bent to form an attachment area. A bead is placed over both of the wires and the wires are then bent in opposite directions to form a V-shape such that the wires diverge from each other at an angle that is symmetrical about a center line of the lure body. In embodiments that use an odd number of wires, one of the wires may be placed along the center line of the lure body. Swivels are then used to attach spinner blades to the end of each wire, which is formed as a loop. Since the blades are positioned symmetrically with respect to the center line of the lure body, the lure runs free through the water and produces increased vibration to help attract fish.

The above description is considered that of the preferred embodiments only. Modification of the invention will occur to those skilled in the art and to those who make or use the invention. Therefore, it is understood that the embodiments shown in the drawings and described above are merely for illustrative purposes and not intended to limit the scope of the invention, which is defined by the following claims as interpreted according to the principles of patent law, including the doctrine of equivalents.

What is claimed is:

1. A fishing lure, comprising:
a hook including an eyelet;
a wiring harness including a first wire and a second wire, each of the first and second wires having a first loop attaching the first and second wires to the eyelet of the hook at a first end, a central region shaped for attaching the lure to a fishing line and a second loop at a second end, wherein the first and second wires are substantially parallel between the first loop and the central region and diverge from the central region at an angle that is symmetrical about a center line;
a lure body formed around the eyelet of the hook, the center line extending along a longitudinal portion of the lure body;
a first spinner blade and a second spinner blade, each including an aperture approximate one end of the first and second spinner blades; and
a first swivel and a second swivel, wherein the first swivel attaches the first spinner blade to the second loop of the first wire and the second swivel attaches the second spinner blade to the second loop of the second wire.

2. The lure of claim 1, wherein the first and second spinner blades are willow-leaf shaped spinners.

3. The lure of claim 1, wherein the first and second spinner blades are tear-drop shaped spinners.

4. The lure of claim 1, wherein the lure body is made of lead.

5. The lure of claim 1, wherein the lure body is shaped to receive a skirt along an end of the lure body that extends around the hook.

6. The lure of claim 5, further including:
a plastic skirt positioned on the lure body and including a fringed portion, which covers a shaft of the hook.

7. The lure of claim 1, wherein the hook is one of a barbed and a barbless hook.

8. The lure of claim 1, wherein the angle is between about ten and forty degrees.

9. The lure of claim 1, wherein the wiring harness further includes:
a third wire, the third wire having a first loop for attaching the third wire to the eyelet of the hook at a first end, a central region shaped for attaching the lure to a fishing line and a second loop at a second end, and wherein the first, second and third wires are substantially parallel between the first loops and the central region and the third wire is symmetrically positioned between the first and second wires as the first, second and third wires diverge from the central region;
a third spinner blade including an aperture approximate one end of the third spinner blade; and
a third swivel, wherein the third swivel attaches the third spinner blade to the second loop of the third wire.

10. A fishing lure, comprising:
a hook including an eyelet;
a wiring harness including a plurality of wires, each of the wires having a first loop attaching the wires to the eyelet of the hook at a first end, a central region shaped for attaching the lure to a fishing line and a second loop at a second end, wherein the wires are substantially parallel between the first loop and the central region and diverge from the central region at angles that are symmetrical about a center line;
a lure body formed around the eyelet of the hook, the center line extending along a longitudinal portion of the lure body;
a plurality of spinner blades, each including an aperture approximate one end of the blades; and
a plurality of swivels, wherein the swivels each attach one of the spinner blades to a different one of the second loops.

11. The lure of claim 10, wherein the spinner blades are willow-leaf shaped spinners.

12. The lure of claim 10, wherein the spinner blades are tear-drop shaped spinners.

13. The lure of claim 10, wherein the lure body is made of lead.

14. The lure of claim 10, wherein the lure body is shaped to receive a skirt along an end of the lure body that extends around the hook.

15. The lure of claim 14, further including:
a plastic skirt positioned on the lure body and including a fringed portion, which covers a shaft of the hook.

16. The lure of claim 1, wherein the hook is one of a barbed and a barbless hook.

17. The lure of claim 1, wherein the angle is between about ten and forty degrees.

18. A fishing lure, comprising:
a hook including an eyelet, wherein the hook is one of a barbed and a barbless hook;
a wiring harness including a plurality of wires, each of the wires having a first loop attaching the wires to the eyelet of the hook at a first end, a central region shaped for attaching the lure to a fishing line and a second loop at a second end, wherein the wires are substantially parallel between the first loop and the central region and diverge from the central region at angles that are symmetrical about a center line;
a lure body formed around the eyelet of the hook, the center line extending along a longitudinal portion of the lure body;
a plurality of spinner blades, each including an aperture approximate one end of the blades; and
a plurality of swivels, wherein the swivels each attach one of the spinner blades to a different one of the second loops, and wherein the angle is between about ten and forty degrees.

19. The lure of claim 18, wherein the spinner blades are at least one of willow-leaf shaped spinners and tear-drop shaped spinners.

20. The lure of claim 18, wherein the lure body is made of lead and is shaped to receive a skirt along an end of the lure body that extends around the hook.
